(19) United States
(12) Patent Application Publication
(10) Pub. No.: US 2024/0246220 A1
(43) Pub. Date: Jul. 25, 2024

(54) TOOL HOLDER

(71) Applicant: Jun-Fan CHEN, Taichung City (TW)

(72) Inventor: Jun-Fan CHEN, Taichung City (TW)

(21) Appl. No.: 18/157,718

(22) Filed: Jan. 20, 2023

(51) Int. Cl. B25H 3/04

(52) U.S. Cl. CPC B25H 3/04

(57) ABSTRACT

A tool holder, including: a base; and two blocking portions, disposed on the base in interval and defining a receiving space and an entrance which are in communication with each other, the two blocking portions being relatively movable, the entrance being configured to allow insertion of a received portion of a tool into the receiving space, the two blocking portions being configured to block the received portion received within the receiving space.

### BACKGROUND OF THE INVENTION

### Field of the Invention

The present invention relates to a tool holder.

### Description of the Prior Art

During the assembly/disassembly process of objects or products, it is usually necessary to use specific assembly/disassembly tools in order to reliably connect many parts or disassemble without damaging the objects or products. It is common to use hand tools to drive members, such as wrenches, pliers, mallets, sockets or scissors screws, bolts, pins or the like, to connect parts s of connecting parts.

There are various types and various sizes of connectors, and there are therefore a variety of hand tools needed to cooperate with the various connectors. Generally, hand tools are placed in drawers, trolleys or other storage spaces. However, there is no positioning structure in the storage space such that the hand tools are stacked and placed randomly, making it difficult for users to find the required hand tools, and the hand tools jam, interfere, and collide with each other, causing unnecessary damage to the hand tools.

The present invention is, therefore, arisen to obviate or at least mitigate the above-mentioned disadvantages.

### SUMMARY OF THE INVENTION

The main object of the present invention is to provide a tool holder which can hold a tool stably and store the tool neatly.

To achieve the above and other objects, a tool holder, including: a base; and two blocking portions, disposed on the base in interval and defining a receiving space and an entrance which are in communication with each other, the two blocking portions being relatively movable, the entrance being configured to allow insertion of a received portion of a tool into the receiving space, the two blocking portions being configured to block the received portion received within the receiving space.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a stereogram showing a plurality of bases connected in series according to a preferable embodiment of the present invention;

FIG. 3 is a breakdown drawing of a preferable embodiment of the present invention;

FIGS. 4 and 5 are drawings showing operation of a blocking portion according to a preferable embodiment of the present invention;

FIGS. 6 and 7 are drawings showing using a tool holder to hold a tool at various places according to a preferable embodiment of the present invention; and

FIG. 8 is a side view according to preferable embodiment of the present invention.

### DETAILED DESCRIPTION OF THE PREFERRED EMBODIMENTS

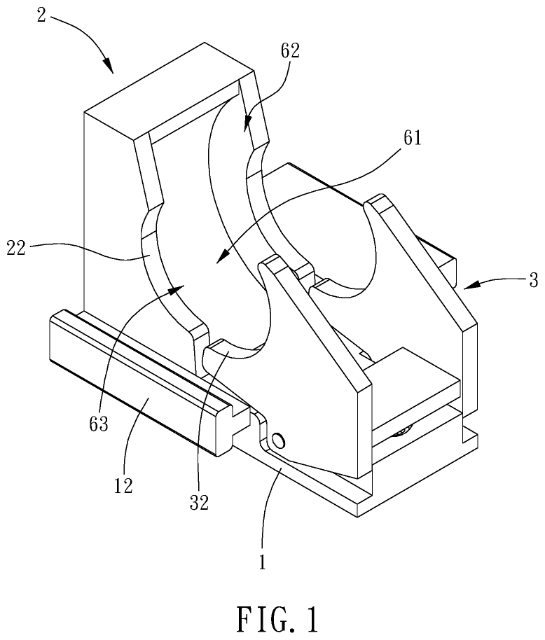

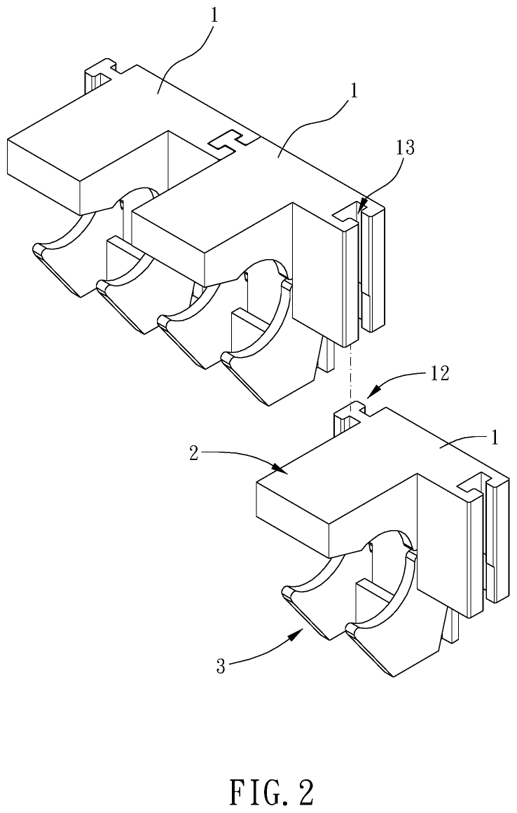

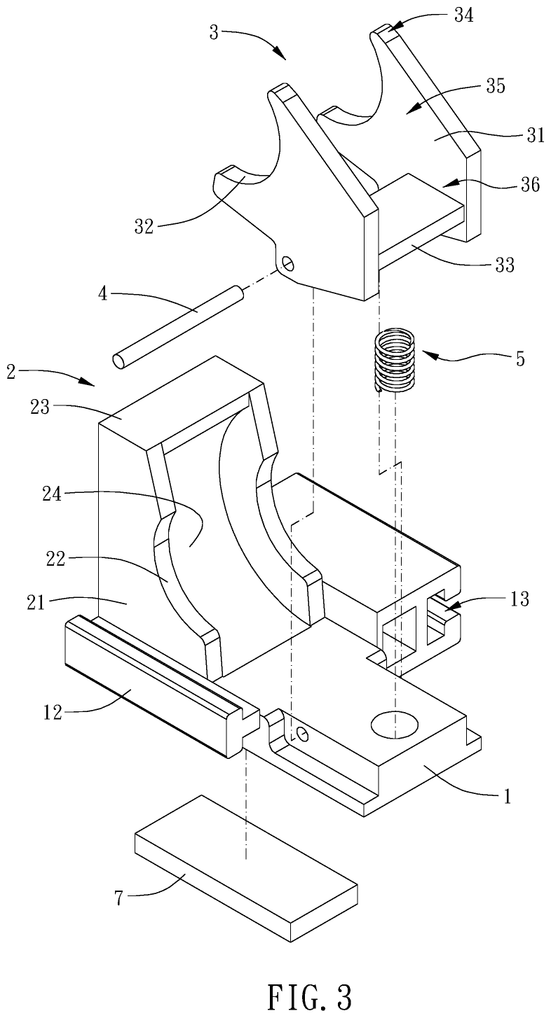

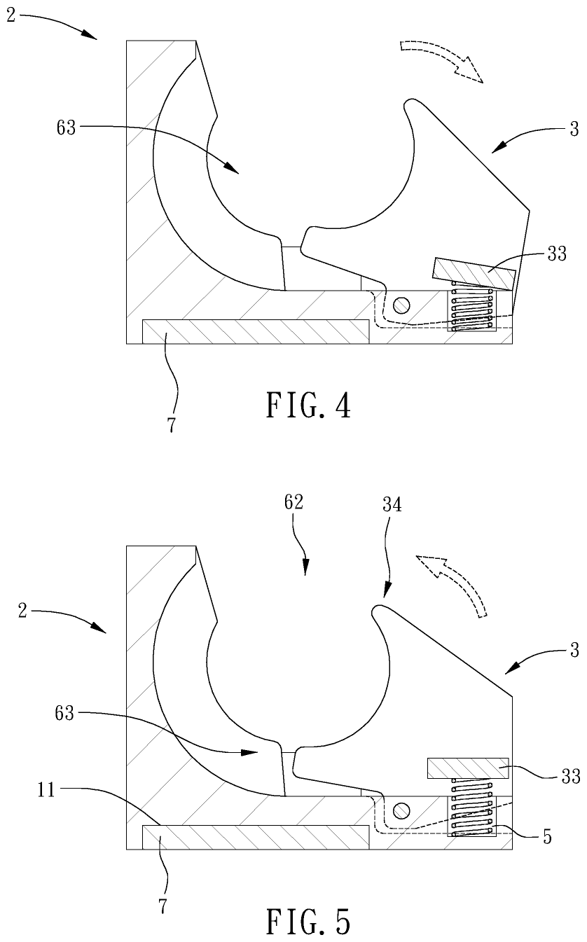

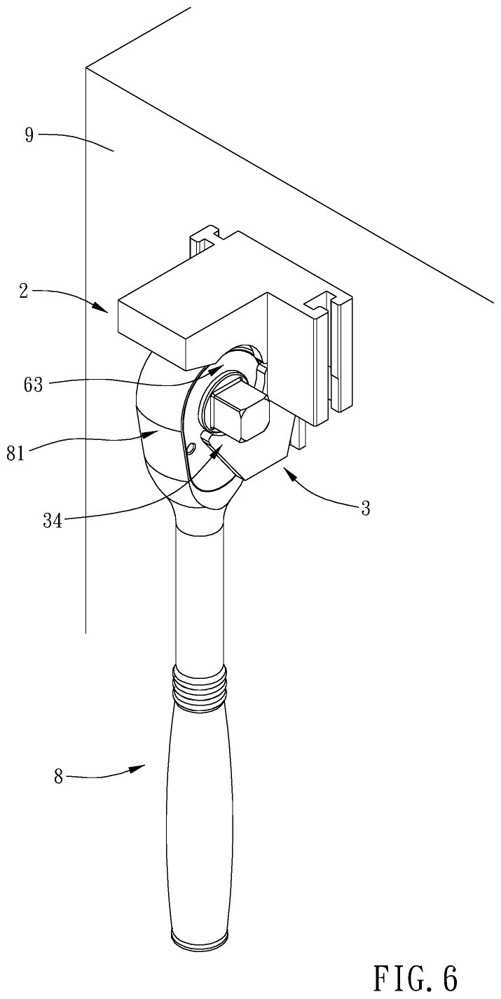

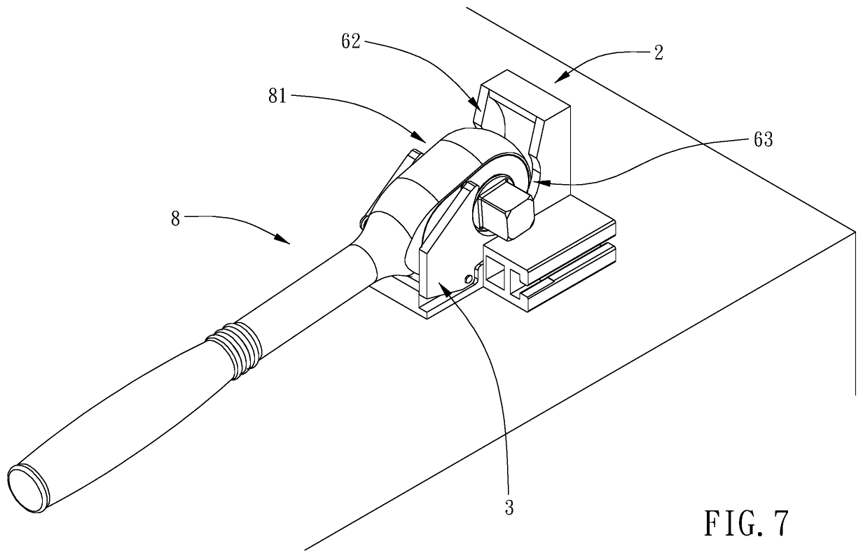

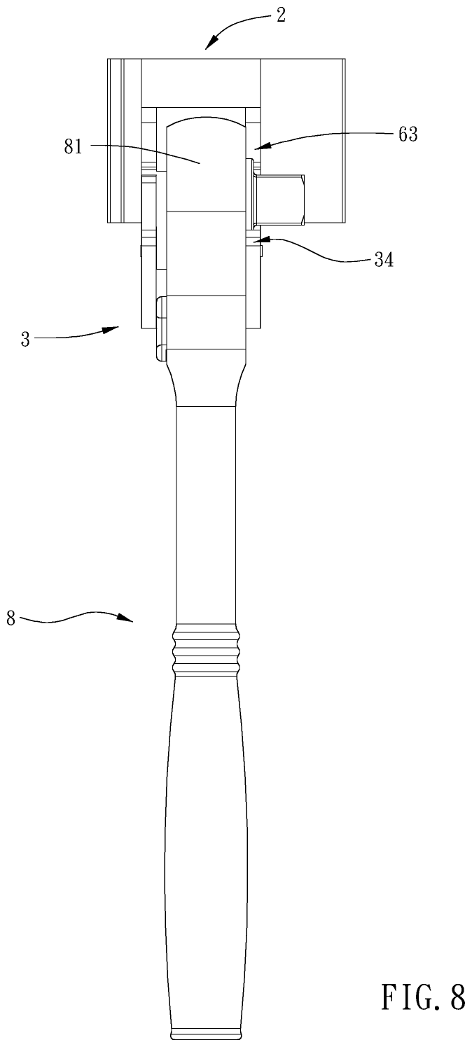

Please refer to FIGS. 1 to 8 for a preferable embodiment of the present invention. A tool holder of the present invention includes a base 1 and two blocking portions.

The two blocking portions is disposed on the base 1 in interval and define a receiving space 61 and an entrance 62 which are in communication with each other, the two blocking portions are relatively movable, the entrance 62 configured to allow insertion of a received portion 81 (such as a working head of a wrench) of a tool 8 into the receiving space 61, and the two blocking portions are configured to block the received portion 81 within the receiving space 61. Since the two blocking portions are relatively movable, the dimensions of the entrance 62 and the receiving space 61 are changeable so that it is easy to put in or take out the tool 8.

Specifically, the two blocking portions includes a first blocking portion 2 and a second blocking portion 3, the first blocking portion 2 extends integrally from the base 1, and the second blocking portion 3 is rotatably connected to the base 1; the base 1 and the first blocking portion 2 are integrally formed of one piece, which is in favor of mass production and structural strength. Specifically, the tool holder further includes an elastic member 5, the elastic member 5 is disposed between the base 1 and the second blocking portion 3, and the elastic member 5 biases the second blocking portion 3 toward the first blocking portion 2, so that the second blocking portion 3 can clamp the received portion 81 automatically and avoid easy disengagement of the received portion 81 from the second blocking portion 3.

In this embodiment, the second blocking portion 3 further includes an abutting portion 33, a side of the abutting portion 33 is abutted against the elastic member 5, and another side of the abutting portion 33 is configured to be abutted against the received portion 81. As such, the elastic force of the elastic member 5 can further act on the received portion 81 of the tool 8 through the abutting portion 33, so as to provide an additional restraint different from the first blocking portion 2 and the second blocking portion 3, which can stably hold the tool 8.

The second blocking portion 3 is rotatably connected to the base 1 by a shaft 4, the entrance 62 is open in a direction transverse to an axial direction of the shaft 4, the first blocking portion 2 and the second blocking portion 3 further define two passageways 63, the two passageways 63 are coaxially arranged in a direction parallel to the axial direction of the shaft 4, the two passageways 63 are in communication with the receiving space 61 and the entrance 62, respectively, and the two passageways 63 are configured to correspond to the received portion 81. For example, the square drive head on the working head of a ratchet wrench passes through one of the two passageways 63. Specifically, the second blocking portion 3 further includes a first side opening 35 and a second side opening 36 which are in communication with each other laterally, the first side opening 35 is a part of the entrance 62, the second side opening 36 is in communication with the receiving space 61 and in communication with the first side opening 35 laterally, and the second side opening 36 is configured for a portion of the tool 8 (such as a handle portion of a wrench) to pass therethrough.

Preferably, an end of the second blocking portion 3 remote from the base 1 includes at least one hook 34, and the at least one hook 34 is configured to be hooked on the received portion 81 so that the tool 8 can not only be placed in a drawer or a flat surface but also be hanged on the wall. Relative to the base 1, the hook 34 is higher than a center of the passageway 63 so that the received portion 81 can be hooked by the hook 34 stably.

In this embodiment, the first blocking portion 2 includes two first side boards 21, a first blocking board 23 and a second blocking board 24, the first blocking board 23 and the second blocking board 24 are laterally connected to and between the two first side boards 21, and a side of each of the two first side boards 21 adjacent to the second blocking portion 3 includes a first concave 22. The second blocking portion 3 further includes two second side boards 31, and the abutting portion 33 laterally extends between the two second side boards 31 to define the first side opening 35 and the second side opening 36. The first side opening 35 and the first blocking board 23 are at the same side, and the second side opening 36 faces the second blocking board 24. An end of each of the two second side boards 31 remote from the base 1 includes the at least one hook 34, a side of each of the two second side boards 31 adjacent to the first blocking portion 2 includes a second concave 32, and the first concave 22 and the second concave 32 form the passageway 63.

Preferably, the base 1 further includes a first assembling portion 12 and a second assembling portion 13, and the first assembling portion 12 of the base 1 is configured to be detachably assembled to the second assembling portion 13 of another said base 1 so that a plurality of said base 1 can be connected in series for use. In this embodiment, the first assembling portion 12 is an engaging block, the second assembling portion 13 is an engaging slot, and the first assembling portion 12 is slidably engaged with the second assembling portion 13.

Preferably, a side of the base 1 facing away from the two blocking portions includes a recess 11, a magnetic member 7 is received in the recess 11 so that the base 1 is magnetically attached to a magnetically attracted member 9 through the magnetic member 7, and thus the tool holder is easy and quick to use and is kept stable because of the action of magnetic force.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A tool holder, including:
a base; and
two blocking portions, disposed on the base in interval and defining a receiving space and an entrance which are in communication with each other, the two blocking portions being relatively movable, the entrance being configured to allow insertion of a received portion of a tool into the receiving space, the two blocking portions being configured to block the received portion received within the receiving space.

2. The tool holder of claim 1, wherein the base further includes a first assembling portion and a second assembling portion, the first assembling portion of the base is configured to be detachably assembled to the second assembling portion of another said base.

3. The tool holder of claim 1, wherein the two blocking portions include a first blocking portion and a second blocking portion, the first blocking portion extends integrally from the base, and the second blocking portion is rotatably connected to the base.

4. The tool holder of claim 3, further including an elastic member, wherein the elastic member is disposed between the base and the second blocking portion, and the elastic member biases the second blocking portion toward the first blocking portion.

5. The tool holder of claim 4, wherein the second blocking portion further includes an abutting portion, a side of the abutting portion is abutted against the elastic member, and another side of the abutting portion is configured to be abutted against the received portion.

6. The tool holder of claim 3, wherein the second blocking portion is rotatably connected to the base by a shaft, the entrance is open in a direction transverse to an axial direction of the shaft, the first blocking portion and the second blocking portion further define two passageways, the two passageways are coaxially arranged in a direction parallel to the axial direction of the shaft, the two passageways are in communication with the receiving space and the entrance, respectively, and the two passageways are configured to correspond to the received portion.

7. The tool holder of claim 3, wherein an end of the second blocking portion remote from the base includes at least one hook, and the at least one hook is configured to be hooked on the received portion.

8. The tool holder of claim 3, wherein the second blocking portion is rotatably connected to the base by a shaft, the entrance is open in a direction transverse to an axial direction of the shaft, the second blocking portion further includes a first side opening and a second side opening which are in communication with each other laterally, the entrance is a part of the first side opening, the second side opening is in communication with the receiving space and in communication with the first side opening laterally, and the second side opening is configured for a portion of the tool to pass therethrough.

9. The tool holder of claim 1, wherein a side of the base facing away from the two blocking portions includes a recess, and a magnetic member is received in the recess so that the base is magnetically attached to a magnetically attracted member through the magnetic member.

10. The tool holder of claim 5, wherein the base further includes a first assembling portion and a second assembling portion, the first assembling portion of the base is configured to be detachably assembled to the second assembling portion of another said base; the second blocking portion is rotatably connected to the base by a shaft, the entrance is open in a direction transverse to an axial direction of the shaft, the first blocking portion and the second blocking portion further define two passageways, the two passageways are coaxially arranged in a direction parallel to the axial direction of the shaft, the two passageways are in communication with the receiving space and the entrance, respectively, and the two passageways are configured to correspond to the received portion; an end of the second blocking portion remote from the base includes at least one hook, and the at least one hook is configured to be hooked on the received portion; the second blocking portion further includes a first side opening and a second side opening which are in communication with each other laterally, the entrance is a part of the first side opening, the second side opening is in communication with the receiving space and in communication with the first side opening laterally, and the second side opening is configured for a portion of the tool to partially to pass therethrough; a side of the base facing away from the two blocking portions includes a recess, and a magnetic member is received in the recess so that the base is magnetically attached to a magnetically attracted member through the magnetic member; the first blocking portion includes two first side boards, a first blocking board and a second blocking board, the first blocking board and the second blocking board are laterally connected to and between the two first side boards, a side of each of the two first side boards adjacent to the second blocking portion includes a first concave, the second blocking portion further includes two second side boards, the abutting portion laterally extends between the two second side boards to define the first side opening and the second side opening, the first side opening and the first blocking board are at the same side, the second side opening faces the second blocking board, an end of each of the two second side boards remote from the base includes the at least one hook, a side of each of the two second side boards adjacent to the first blocking portion includes a second concave, and the first concave and the second concave form the passageway; the first assembling portion is an engaging block, the second assembling portion is an engaging slot, and the first assembling portion is slidably engaged with the second assembling portion; relative to the base, the hook is higher than a center of the passageway.
